(19) United States
(12) Patent Application Publication
(10) Pub. No.: US 2005/0233720 A1
(43) Pub. Date: Oct. 20, 2005

(54) Method of suppressing frequency-shift keying (FSK) interference

(75) Inventor: James C. Francis, Fairport, NY (US)

Correspondence Address: BASCH & NICKERSON LLP, 1777 PENFIELD ROAD, PENFIELD, NY, 14526, US

(73) Assignee: The Titan Corporation, San Diego, CA (US)

(21) Appl. No.: 11/106,263

(22) Filed: Apr. 14, 2005

Related U.S. Application Data
(60) Provisional application No. 60/563,689, filed on Apr. 20, 2004.

(51) Int. Cl. H04B 1/00; H04B 15/00; H04B 1/10

(52) U.S. Cl. 455/223; 455/63.1; 455/283; 455/296

(57) ABSTRACT

The present invention is a method and apparatus for suppressing frequency-shift keying (FSK) interference in high-frequency radio signals, and more particularly to excision filtering of a signal followed by noise blanking, wherein the energy at the output of the noise blanking operation is minimized.

Priority is claimed from U.S. Provisional Application No. 60/563,689, filed Apr. 20, 2004, by James C. Francis, which is hereby incorporated by reference in its entirety.

This invention relates generally to a method of suppressing frequency-shift keying (FSK) interference, and more particularly to excision filtering of a signal followed by noise blanking, wherein the energy at the output of the noise blanking operation is minimized.

### BACKGROUND AND SUMMARY OF THE INVENTION

It is a common problem for digital communication systems in the high-frequency (HF) radio spectrum to encounter interference, and frequency-shift keying (FSK) is one of the most common types of interference. Consequently, HF communication systems may employ methods to suppress this interference.

Modern HF communication systems use digital signal processing (DSP) techniques. In the context of a sampled system, one method of suppressing interference is to introduce a finite impulse response (FIR) filter, commonly referred to as an excision filter. The impulse response of the filter, hₙ, is designed adaptively in response to the characteristics of the input signal, xₙ.

One approach is described in U.S. Pat. No. 5,259,030, the disclosure of which is hereby incorporated by reference in its entirety. The design criteria is to minimize the energy of output signal yₙ, where h₀ is constrained to a constant. The energy of the output signal yₙ is minimized because the input signal xₙ is dominated by the interferer. The constraint on h₀ eliminates the all-zero solution. The calculation of hₙ may be sample-by-sample where the filter is updated with each new value of yₙ, or it may be block-oriented where the filter is updated each time a block of samples of yₙ become available. Block-oriented design is preferable whenever the associated delay may be tolerated.

Consider the case of such a filter design in the presence of pure (interferer only) binary FSK. Suppose further that the excision filter has two zeros, one at each of the binary frequencies of the interferer. The response of the filter to either frequency is zero in the steady state, but at the onset of the input, the filter has a transient. Similarly, when subjected to the interfering signal, the filter has a transient whenever there is a transition in frequency (i.e. on symbol transitions). This impulsive noise may be suppressed by using a noise blanker that simply zeroes the output of the filter whenever the energy of the output exceeds a certain threshold.

This has been the historical approach to this problem. The shortcoming of this method is that this filter design minimizes the energy of the output of the excision filter, or rather, the input to the noise blanker. The energy at the output of the noise blanker, although significantly reduced, is not optimal. The following disclosure will describe a method that minimizes the energy at the output of the noise blanker, and is therefore optimal.

In accordance with an embodiment of the disclosure, there is provided a method of suppressing frequency-shift keying interference in a radio signal, comprising: applying an excision filter to the signal; and inputting the output of the excision filter into a noise blanker to identify at least one signal sample instant to be blanked, wherein the energy of the output of the noise blanker is minimized.

In accordance with another aspect of the disclosed method there is provided a method of suppressing interference in a radio signal, comprising: obtaining an approximation hₐ to an excision filter; applying the approximate excision filter ha to the radio signal to generate an output from the excision filter; inputting the output of the excision filter into a noise blanker to identify a set of sample instants that are to be blanked, wherein the set of sample instants is denoted B; calculating an optimal filter to reduce the energy of the samples that will not be blanked, using the equation

$${min}_{\underline{h}} {\sum }_{n , n ∉ B} {\vert {\underline{x}}_{n} - {( Xh )}_{n} \vert}^{N} ;$$

applying the optimal excision filter h to the radio signal to generate a filtered signal output from the optimal excision filter; and inputting the filtered signal into the noise blanker, wherein a signal output from the noise blanker has suppressed interference.

### BRIEF DESCRIPTION OF THE DRAWINGS

FIG. 1 is a plot of the magnitude of a Fourier transform of an impulse response;

FIG. 2 is a plot of an exemplary excision filter output in accordance with one aspect of the present invention;

FIG. 3 is a plot of the output of an optimal excision filter in accordance with an embodiment of the present invention; and

FIG. 4 is a general flowchart illustrating a method for accomplishing aspects of the present invention.

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by the appended claims.

### DESCRIPTION OF THE PREFERRED EMBODIMENT

For a general understanding of the present invention, reference is made to the drawings. In the drawings, like reference numerals have been used throughout to designate identical elements.

Considering, again, the case of pure binary FSK, suppose the interferer is transmitting a sequence of binary symbols, sₖ, where sₖε{0,1}. When the interferer transmits a 0 it outputs a signal that is a complex sinusoid of frequency [symbol] ₀, and when it transmits a 1 it outputs a signal that is a complex sinusoid of frequency [symbol] ₁. Suppose that [symbol] ₀₌₀ and [symbol] ₁=π. Suppose that the symbol period is M=8 samples, and that the interferer transmits the sequence sₖ={0,1,0,0,0, . . . }. Then the interferer signal would be
xₙ{1,1,1,1,1,1,1,1,1,−1,1,−1,1,−1,1,−1,1,1,1,1,1,1,1,1,1,1,1,1,1,1,1,1,1,1,1,1,1,1,1,1, . . . }

Denoting the first n as 0, the impulse response of the excision filter may be determined as:

$${min}_{\underline{h}} {‖ \underline{x} - Xh ‖}^{2} \qquad ( 1 )$$

where the impulse response of the excision filter is given by:
{1,−h₀,−h₁} (2)

Denote the first tuple as 0. x is a column vector taken from xₙ, and the n^{th} tuple of x is xₙ₊₂. The first column of the matrix X is taken from xₙ delayed by 1 sample, and the n^{th} tuple of the first column is xₙ₊₁. The second column is xₙ delayed by 2 samples, and the n^{th} tuple of the second column is xₓ₊₀. So,

$$\underline{x} = [ \begin{matrix}1 \\ 1 \\ 1 \\ 1 \\ 1 \\ 1 \\ 1 \\ - 1 \\ 1 \\ - 1 \\ ⋮\end{matrix} ] X = [ \begin{matrix}1 \\ 1 \\ 1 \\ 1 \\ 1 \\ 1 \\ 1 \\ 1 \\ - 1 \\ 1 \\ ⋮\end{matrix} \begin{matrix}1 \\ 1 \\ 1 \\ 1 \\ 1 \\ 1 \\ 1 \\ 1 \\ 1 \\ - 1 \\ ⋮\end{matrix} ] \qquad ( 3 )$$

The optimal h is given by a standard result from linear algebra as:
h=(X*X)⁻¹X*x (4)
where it is assumed that columns of X are linearly independent. The * operator denotes conjugate transpose. Suppose that number of tuples of x is four symbol periods (32 samples), then it may be determined that

$$h = [ \begin{matrix}0.083 \\ 0.833\end{matrix} ] \qquad ( 5 )$$

and the resulting excision filter has impulse response
{1,−0.083,−0.833}

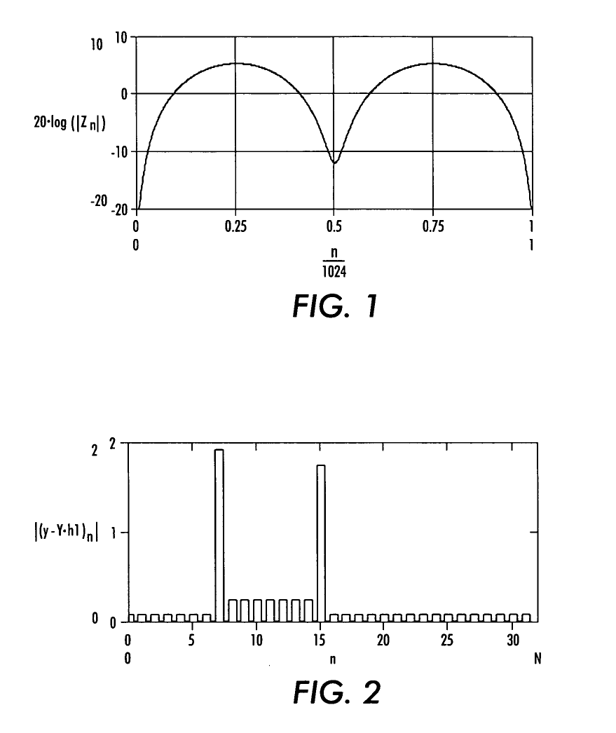

A plot of the magnitude of the Fourier transform of this sequence appears in FIG. 1. In FIG. 1, the horizontal scale is normalized to 2π. Notice that the filter has two notches, one is at 0 and the other is at π. Or rather, there is one at [symbol] ₀ and the other is at [symbol] ₁. The notch at 0 is deeper because the filter was “trained” on a signal where three of the four symbol periods were symbol 0 ( [symbol] ₀). A plot of the output of the excision filter appears in FIG. 2.

Referring to FIG. 2, it will be noted that the large filter outputs at samples 7 and 15. This results from the symbols transitions from 0 to 1, and 1 to 0, respectively. Notice also the filter output at the other sample instants is nonzero, and larger where the interferer symbol value is 1.

To suppress the large filter outputs at symbol transitions, a noise blanker is generally used. The noise blanker outputs the input, if the energy of the input is below a threshold (a threshold of 1 would work in this example). Alternatively, the noise blanker outputs a zero, if the energy of the input is above a threshold. Thus, the noise blanker “blanks” the impulse noise at symbol transitions.

The problem with the historical approach to this problem, as described previously, is that it minimizes the output of the excision filter. It reduces the output of the noise blanker, but it does not obtain a minimal energy output from the noise blanker, which is what is really desired. The optimal excision filter is, therefore, given by:

$$h = [ \begin{matrix}0 \\ 1\end{matrix} ] \qquad ( 6 )$$

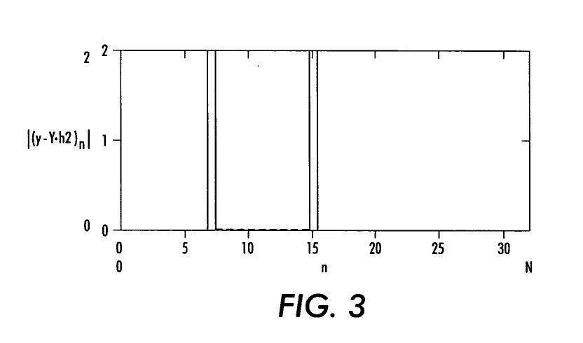

A plot of the output of the optimal excision filter is illustrated in FIG. 3. Because a noise blanker will also suppress outputs at samples 7 and 15, this is a better solution than obtained previously. Indeed, this solution will produce minimal output energy from the noise blanker. In other words, in one embodiment, it may be desireable to have the excision filter subsequently, iteratively refined by the processing of the noise blanker. Such an embodiment may include storage of signals or portions thereof in a feedback or similar iteratively refined loop or circuit.

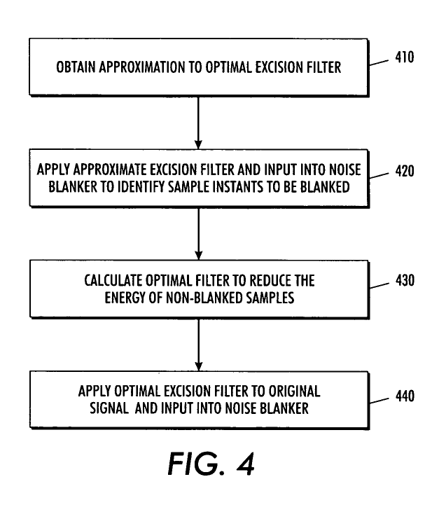

One aspect of the present invention, therefore, is to minimize the output of the noise blanker in accordance with the following method:
1) Obtain an approximation ha to the optimal excision filter as illustrated at Step 410 of FIG. 4. Such an approximation may be simply to minimize the output energy of the excision filter, as has been the historical approach to this problem.
2) Apply the approximate excision filter hₐ and input this into the noise blanker to identify the sample instants that will be blanked, step 420. (Retain the original unprocessed signal for later processing.) Denote this set of sample instants B.
3) Calculate the optimal filter to reduce the energy of the samples that will not be blanked as in step 430

$${min}_{\underline{h}} {\sum }_{n , n ∉ B} {\vert {\underline{x}}_{n} - {( Xh )}_{n} \vert}^{2} \qquad ( 7 )$$

As will be appreciated by those knowledgeable in filter design, an exponent of N=2 has the advantage that the resulting filter design objective (“minimum output energy”) is easily understood, and analytically convenient because of the closed form solution of Equation (4). Other exponents (i.e., N=A≠2) may be used. For example, an exponent of N=1 may be computationally reasonable because Linear Programming techniques can be used (i.e. the Simplex algorithm). In other problems where one minimizes a sum of errors other exponents may be reasonable, for example, on a channel that is subject to additive noise that is impulsive, a smaller exponent of N=1 may make considerable sense. It is also conceivable that in the above equation (Eq. 7), the unity weighting of the errors being summed may be replaced with non-unity weighting, including where the weighting of each error in the summation is different.
4) Apply the optimal excision filter h to the original signal and input this into the noise blanker at step 440.

It is, therefore, apparent that there has been provided, in accordance with the present invention, a method for suppressing FSK interference, and more particularly to excision filtering of a signal followed by noise blanking, wherein the energy at the output of the noise blanking operation is minimized. While this invention has been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the appended claims.

1. A method of suppressing frequency-shift keying interference in a radio signal, comprising:
applying an excision filter to the signal; and
inputting the output of the excision filter into a noise blanker to identify at least one signal sample instant to be blanked, wherein the energy of the output of the noise blanker is minimized.

2. The method of claim 1 above, wherein the excision filter is subsequently iteratively refined by the processing of the noise blanker.

3. The method of claim 2, further comprising storing at least a portion of a signal for iterative refinement thereof.

4. A method of suppressing interference in a radio signal, comprising:
obtaining an approximation hₐ to an excision filter;
applying the approximate excision filter hₐ to the radio signal to generate an output from the excision filter;
inputting the output of the excision filter into a noise blanker to identify a set of sample instants that are to be blanked, wherein the set of sample instants is denoted B;
calculating an optimal filter to reduce the energy of the samples that will not be blanked, using the equation
$${min}_{\underline{h}} {\sum }_{n , n ∉ B} {\vert {\underline{x}}_{n} - {( Xh )}_{n} \vert}^{N} ;$$
applying the optimal excision filter h to the radio signal to generate a filtered signal output from the optimal excision filter; and
inputting the filtered signal into the noise blanker, wherein a signal output from the noise blanker has suppressed interference.

5. The method of claim 4, wherein exponent N=2.

6. The method of claim 4, wherein exponent N≠2.

7. The method of claim 4, wherein each error in the summation is differently weighted.
